(19) United States
(12) Patent Application Publication
(10) Pub. No.: US 2010/0330230 A1
(43) Pub. Date: Dec. 30, 2010

(54) FERMENTED SOYMILK AND METHOD FOR IMPROVING THE ORGANOLEPTIC PROPERTIES OF FERMENTED SOYMILK

(75) Inventors: Gian Paolo Strozzi, Novara (IT); Giovanni Mogna, Novara (IT); Luca Mogna, Milano (IT)

Correspondence Address: Pearne & Gordon LLP, 1801 East 9th Street, Suite 1200, Cleveland, OH, 44114-3108, US

(73) Assignee: PROBIOTICAL S.P.A., I-28100 NOVARA (IT)

(21) Appl. No.: 12/919,584

(22) PCT Filed: Feb. 25, 2009
(86) PCT No.: PCT/EP09/52208

§ 371 Date: Sep. 9, 2010

(30) Foreign Application Priority Data
Feb. 26, 2008 (IT) MI2008A000306

(51) Int. Cl. A23C 11/10

(52) U.S. Cl. 426/18; 426/46; 426/598

(57) ABSTRACT

The present invention relates to fermented soymilk and to a method for improving the organoleptic properties of fermented soymilk.

The present invention relates to fermented soymilk and to a method for improving the organoleptic properties of fermented soymilk.

There are some categories of consumers who may develop a certain intolerance to products of animal origin such as milk and milk products, as a result of which these products can in some cases no longer be used for daily nutrition, or their consumability will in any case be considerably limited. Lactose intolerances and allergies to casein, one of the major protein classes present in milk, are in fact quite wide-spread both among children and adults. A known alternative to using milk of animal origin is the use of milk of substantially vegetable origin and of food products derived therefrom.

Specifically the use of soymilk is known for its salutary properties. Said milk indeed contains fewer calories than cow's milk and its protein content is almost twice as high and its fat concentration lower. It is richer in iron and its percentage of B-group vitamins is equivalent. It is poorer in calcium but has a high content of polyunsaturated fatty acids and is easy to digest. The presence of lecithin may, in addition, considerably contribute to lowering excessive cholesterol and triglyceride levels in the blood, whereas proteins of animal origin, and in particular milk casein, tend to increase these levels.

Soymilk is used in the production of a variety of fermented and unfermented food products. Therefore, although the use of soymilk would, on the one hand, represent a valid of soymilk would, on the one hand, represent a valid alternative to milk of animal origin when it comes to solving intolerance problems, its use is limited, on the other hand, by the poor organoleptic properties of the product itself.

It is known, in fact, that the taste and/or smell of soymilk is very similar to that of beans which will be perceived by consumers at the moment of consumption. Said taste and/or aroma is perceived as “unpleasant” by the average consumer. This taste and/or aroma is believed to be substantially due to the presence in the milk of some compounds comprising alcohol, ketone and/or aldehyde groups, and especially, but not only, hexanal and/or pentanal compounds.

Said alcohol, ketone and/or aldehyde groups are produced by oxidation of the lipid component of soy, notably of the fraction of unsaturated fatty acids, by way of a combined catalytic action mediated by the enzymes lipase, phospholipase and lipoxygenase. The latter class of enzymes is present in soy in particularly high concentrations exceeding those to be found in other vegetable and leguminous organisms such as beans, peas or wheat. The free fatty acids are, in addition, subject to autoxidation reactions due to the catalytic activity of the copper and iron ions normally present in trace amounts in soy seeds.

Following oxidation, linoleic acid and linolenic acid, which both have 18 carbon atoms, give rise to numerous aldehyde compounds such as hexanal, 2,4-decadienal, 2,4-heptadienal, 3-hexanal and 2,4,7-decatrienal.

Said aldehyde molecules are responsible for the occurrence of various unpleasant organoleptic notes, notably the bean-like taste of soy-based or soy-derived products.

The above aldehyde molecules are not generally present in solid and dry soy beans, but are produced, even in significant amounts, when said beans are soaked and ground to produce the so-called “milk”.

The article by P. Scalabrini et al., “Characterization of Bifidobacterium strains for use in soymilk fermentation”, International Journal of Food Microbiology, 39 (1998) 213-219, reports on data regarding the fermentation of soymilk by the strain MB233, which belongs to the species Bifidobacterium breve. It can, in particular, be learned from gas chromatographic analyses that after fermentation for 24 hours the resulting fermented soymilk is substantially free of pentanal, whereas n-hexanal is present in a reduced amount.

The Applicant has found by way of experiment that fermentation of soy milk by the strain MB233 belonging to the species Bifidobacterium breve, as reported on by P. Scalabrini et al., does not in reality allow a product to be obtained having satisfactory organoleptic properties. Practical tastings have, in fact, revealed that the resulting product still smells and, above all, tastes to a non-negligible extent of beans, which makes it unfit for commercial use.

Therefore, the Applicant has set itself the object of finding a method which allows the organoleptic properties of fermented soymilk to be improved so as to substantially eliminate the typical bean-like smell and taste of untreated soymilk.

The Applicant has found that this problem can be solved by a method which comprises the addition of a product of vegetable origin containing starch and/or hydrolysis products thereof and successive fermentation by at least one bacterium selected from the species S. thermophilus.

The product of vegetable origin containing starch and/or hydrolysis products thereof can be obtained by way of thermal, chemical and/or enzymatic treatment of at least one vegetable flour, obtained for example from cereals such as rice, corn, barley, maize, wheat, sorghum, millet, oat, rye, fonio, triticale, or from tuber crop, for example manioc, tapioca, potatoes. Hydrolysis may be partial. Such treatments lead to the obtainment of a product in the form of a viscous liquid (syrup or molasses) or of an aqueous solution containing glucose, maltose and/or fructose, as well as complex carbohydrates having a molecular weight higher than maltose and derived from starch as such or from partially hydrolyzed starch, in variable quantitative proportions to each other.

For the purposes of the present invention, “soymilk” is understood to mean an aqueous extract obtained from preferably yellow, whole soy beans or seeds or from full-fat soy flour, possibly with added vitamins and/or oligoelements and/or salts and/or emulsifiers and/or sweeteners/flavor enhancers such as maple syrup, barley or rice malt, vanilla sugar, unrefined cane sugar. The extract may be whole-grain or refined-grain, i.e. obtained from soy seeds after elimination of the outer shell. Soymilk is a whitish solution in the form of an emulsion or suspension containing carbohydrates, proteins, minerals and oleaginous substances. In general, soymilk contains a quantitative proportion (w/w) of soy beans/flour to water of between 1:4 and 1:18, preferably between 1:6 and 1:15, and more preferably between 1:8 and 1:12.

For the purposes of the present invention, “rest(ing)” is understood to mean a step in which at least one bacterium selected from one or more bacterial strains is grown in soymilk, preferably mixed with at least one product of vegetable origin containing starch and/or hydrolysis products thereof, for a time that is sufficient for its special catalytic and metabolic features to become apparent.

A first object of the present invention is thus a method for improving the organoleptic properties of fermented soymilk, said method comprising:
i) mixing the soymilk with at least one product of vegetable origin containing starch and/or hydrolysis products thereof;
ii) leaving the mixture of step i) to rest with at least one bacterium selected from the species S. thermophilus.

Preferably, said at least one product of vegetable origin containing starch and/or hydrolysis products thereof is used in a quantitative proportion relative to the soymilk varying from 0.1% to 50% v/v, preferably from 1% to 25% v/v, and even more preferably from 2% to 10% v/v. A particularly preferred embodiment of the invention is that in which said proportion is from 3% to 7% v/v.

Preferably, the product of vegetable origin containing starch and/or hydrolysis products thereof is tapioca syrup.

Said tapioca syrup can be obtained with different degrees of qualitative/quantitative conversion of the starch to simple monomers or oligomers such as maltose, glucose and/or fructose.

In a preferred embodiment, the soymilk is pre-heated, prior to the mixing according to step (i) of the method according to the invention, to a temperature varying from 30° C. to 70° C., preferably from 35° C. to 50° C., for a length of time varying from 1 to 30 minutes, preferably from 3 to 15 minutes.

Said at least one bacterium selected from the species S. thermophilus is added, preferably in step (ii), to the mixture and is left to rest. Preferably, said rest is performed at a temperature varying from 30° C. to 49° C., preferably from 35° C. to 46° C., and even more preferably from 39° C. to 44° C.

In view of the chemical characteristics of the above mixture, it is advantageously preferable to work under sterile nitrogen pressure or at least under conditions of reduced oxygen concentration so as to avoid as far as possible oxidation phenomena to the detriment of the lipid component of the soy.

Advantageously, the addition of the product of vegetable origin containing starch and/or hydrolysis products thereof during the method allows the time required for the resting step to be reduced to less than 20 hours. Preferably, the resting process is carried out for a length of time varying from 1 to 20 hours and even more preferably from 2 to 15 hours; with 3 to 10 hours being particularly preferred.

Said at least one bacterium can be used in any form such as, for example, frozen or lyophilized, or originating from a fresh culture.

The at least one bacterium as specified above is preferably added in such an amount as to ensure that the pH value of said resting mixture successively drops until it reaches values that are lower than or equal to 5.5 within the time periods described above, and that are preferably lower than or equal to 5.0, with said value being even more preferably lower than or equal to 4.5.

In a particularly preferred embodiment, the pH value of the mixture according to point i) drops to values lower than or equal to 4.5 within a length of time ranging from 7.5 to 8 hours.

In the method according to the present invention, said at least one bacterium is preferably selected from the strains set out in Table 1:

TABLE 1

| | | | | Reference |
|---|---|---|---|---|
| Deposit | | Date of | | name for |
| number | Species | deposit | Proprietor | the patent |
| DSM 16591 | Streptococcus | June 26, | ANIDRAL | YOSO 1 |
| | thermophilus | 2004 | S. R. L. | |
| DSM 16593 | Streptococcus | June 26, | ANIDRAL | YOSO 2 |
| | thermophilus | 2004 | S. R. L. | |
| DSM 17843 | Streptococcus | Dec. | ANIDRAL | YOSO 3 |
| | thermophilus | 21, 2005 | S. R. L. | |

The strains set out in Table 1 were deposited by Anidral S.p.A. (Via Pietro Custodi 12, 28100, Novara, NO, Italy) with the DSMZ (Deutsche Sammlung von Mikroorganismen and Zellkulturen GmbH, Inhoffen Str. 7B, D-38124 Brunswick, Germany) at the dates specified above.

The strains DSM 16591, DSM 16593 and DSM 17843 (referred to in the following as YOSO 1, YOSO 2 and YOSO 3, respectively) can be cultivated, preferably at 44° C. for at least 5 hours under aerobic conditions, in M17 broth according to Terzaghi (ref. Merck catalogue 1.15029).

The strains YOSO 1, YOSO 2 and YOSO 3 are in the form of short chains of spherical shape. They are optionally anaerobic, gram-positive and catalase-negative bacteria. They are characterized by a failure to grow at 10° C. in 40% w/w bile acid and 6.5% w/w NaCl, but they do grow at 45° C. In addition, they are characterized in that they produce L-lactic acid and do not hydrolyze arginine and esculin. They do not express the enzymes necessary for beta-haemolysis.

They preferably grow in glucose broth at a pH of 4 to 4.5 and in milk at a pH of 4.3 to 4.5.

The addition of bacteria to the soymilk and their resting in the solution containing the soymilk can be implemented according to processes known in the art.

The two steps of the above method do not necessarily have to take place as a defined sequence in time. The Applicant has found in this regard that it is possible to also add said at least one bacterium to the soymilk as such and to mix the complex of “milk+bacterium” only afterwards with at least one product of vegetable origin selected from those indicated above.

Said steps may take place without waiting periods in between, or a further step may be provided in which the first component (product of vegetable origin or bacterium) added to the soymilk is mixed so as to ensure its complete homogeneity before the second component (bacterium or product of vegetable origin) is added.

Said further mixing step may be continued for a length of time between 1 minute and 1 hour, preferably between 2 minutes and 30 minutes, and particularly preferred between 3 and 15 minutes.

According to another aspect of the invention, the invention relates to soymilk comprising at least one product of vegetable origin containing starch and/or products of at least a partial hydrolysis thereof, said soymilk being fermented by at least one bacterium selected from the species S. thermophilus. Preferably, the at least one bacterium selected from the species S. thermophilus comprises at least one bacterium selected from the strains described in Table 1. In a preferred embodiment, said product can be obtained by means of the methods according to the invention.

According to a further aspect of the invention, the present invention relates to a soy-based food product obtained from soymilk to which at least one product of vegetable origin containing starch and/or hydrolysis products thereof is added and which is fermented by a strain of S. thermophilus, as described above.

The present invention will now be further illustrated with reference to a few embodiments that are provided only for illustrative purposes and not as a limitation of the invention.

### EXAMPLE 1

The method according to the invention has been tested to prepare fermented soymilk in comparison to that known in the art.

A commercially available soymilk, Alpro soya Wevelgem, from Belgium was thermally pre-treated for 30 minutes at 110° C.

Nine samples having the following compositions were prepared:
1. Sample 1—Soymilk+tapioca syrup in a concentration of 4.6% v/v,
2. Sample 2—Soymilk+saccharose in a concentration of 5% v/v and Bifidobacterium breve MB233,
3. Sample 3—Soymilk+tapioca syrup in a concentration of 4.6% v/v and B. breve MB233,
4. Sample 4—Soymilk+saccharose in a concentration of 5% v/v and S. thermophilus YOSO3,
5. Sample 5—Soymilk+tapioca syrup in a concentration of 4.6% v/v and S. thermophilus strain YOSO3,
6. Sample 6—Soymilk+saccharose in a concentration of 5% v/v and S. thermophilus YOSO2,
7. Sample 7—Soymilk+tapioca syrup in a concentration of 4.6% v/v and S. thermophilus strain YOSO2,
8. Sample 8—Soymilk+saccharose in a concentration of 5% v/v and S. thermophilus YOSO1,
9. Sample 9—Soymilk+tapioca syrup in a concentration of 4.6% v/v and S. thermophilus strain YOSO1.

In samples 2, 4, 6 and 8, saccharose was used in a concentration of 5% as a carbon and energy source for the bacterial strain with which the resting step was carried out. In fact, soymilk as such is not generally suitable for fermentation by bacterial strains belonging to the genus Streptococcus and to at least some species of the genus Bifidobacterium in that the oligosaccharides present in said milk are hardly fermentable by said strains.

As for sample 1, said tapioca syrup was added in an amount of 4.6% v/v to the soymilk which, after mixing for 2 minutes, was left to rest for 24 hours at a temperature of 37° C. with constant slight stirring.

As for sample 2, saccharose in an amount of 5% v/v and Bifidobacterium breve MB233 were added to the soymilk which was left to rest for 24 hours at 37° C. with constant slight stirring. Said bacterium originated from a fresh liquid broth culture and was added in a concentration of 3*10⁷ CFU/ml. Said sample was prepared in the following order: addition of the saccharose, short mixing for two minutes, and addition of the strain MB233.

As for sample 3, said tapioca syrup in an amount 4.6% v/v and Bifidobacterium breve MB233 were added to the soymilk which was left to rest for 24 hours at 37° C. with constant slight stirring. Said bacterium originated from a fresh liquid broth culture and was added in a concentration of 3*10⁷ CFU/ml. Said sample was prepared in the order: addition of the tapioca syrup, short mixing for two minutes, and addition of the strain MB233.

As for sample 4, saccharose in an amount of 5% v/v and Streptococcus thermophilus YOSO3 were added to the soymilk which was left to rest for 8 hours at 42° C. with constant slight stirring. Said bacterium originated from a fresh liquid broth culture and was added in such a concentration as to lower the pH to values below 4.5 after 7.5 to 8 hours of resting. As with sample 2, the order of preparation was: addition of the saccharose, short mixing for 2 minutes, and addition of the strain YOSO3.

As for sample 5, said tapioca syrup in an amount of 4.6% v/v and S. thermophilus YOSO3 were added to the soymilk and left to ferment for 8 hours at 42° C. with constant slight stirring. The amounts used of the strain YOSO3 were the same as described for sample 4. As with sample 3, the order of preparation was: addition of the tapioca syrup, short mixing for 2 minutes, and addition of the strain YOSO3.

Samples 6 and 8 were prepared according to the same procedure as applied for preparing sample 4, using respectively the strains set forth above. Samples 7 and 9 were prepared according to the same procedure as applied for preparing sample 5, using respectively the strains set forth above. The various portions were left to rest for the lengths of time described above for each sample, during which time the portions were sampled each hour during the first 8 hours. One further evaluation was, in the end, performed after 24 hours for samples 2 and 3, prepared with the strain B. breve MB233.

The samples were then subjected to a smell and taste test in a panel test including 10 persons. Said panel test was carried out with blindfolds and with the samples numbered from 1 to 9, but without any additional information or description. Each person recorded their own impressions concerning their perception of both smell and taste in a table, attributing a score from 0 to 5 to the agreeability and acceptability of the samples under examination. A score of 0 corresponded to the complete absence of a bean-like smell and/or taste, thus denoting a sample fully acceptable from an organoleptic viewpoint, whereas a score of 5 stressed the complete identicalness between the tested sample and the organoleptic characteristics of the initial soymilk, and hence the persistence of the bean-like taste and/or smell.

Table 2 sets out the pH values of each sample at the end of the resting step, as well as the scores assigned thereto in the course of the panel test:

TABLE 2

| | pH after | Total | Average |
|---|---|---|---|
| Sample | resting | score | score |
| 1 | 7.05 | 48 | 4.8 |
| 2 | 4.72 | 41 | 4.1 |
| 3 | 4.60 | 39 | 3.9 |
| 4 | 4.44 | 36 | 3.6 |
| 5 | 4.49 | 4 | 0.4 |
| 6 | 4.35 | 35 | 3.5 |
| 7 | 4.46 | 16 | 1.6 |
| 8 | 4.41 | 40 | 4.0 |
| 9 | 4.30 | 22 | 2.2 |

A persistence of the bean-like smell and taste was identified after 8 hours of the panel test in samples 1, 2, 3, 4, 6 and 8. A significant reduction of said bean-like organoleptic note was found in samples 7 and 9, whereas the organoleptic characteristics were perfectly acceptable in sample 5, fermented with the strain S. thermophilus YOSO 3.

It should be emphasized that in the samples in which an organoleptic improvement was noted, this improvement already started to become perceptible after 4 hours, which shows that the biochemical/metabolic activity of the bacterial strain plays a fundamental role in this regard.

Samples 2 and 3 were left to rest for 24 hours, after which a further organoleptic evaluation was performed, without detecting substantial improvements as compared to the situation at the beginning and after 8 hours.

The above results show that tapioca syrup alone (sample 1) and fermentation with only bacteria (samples 2, 4, 6 and 8) are unable to eliminate the undesired organoleptic properties of fermented soymilk. The results of sample 5, and in part also those of samples 7 and 9, show that specific combinations of appropriate bacterial strains with an efficient amount of tapioca syrup are able to reduce—and in one instance to almost completely eliminate—the unfavorable organoleptic notes to be found in fermented soymilk in the prior art. While a specific interaction can in particular be noted between the strains of Streptococcus thermophilus and tapioca syrup, this feature could not be found at all, or only to a negligible extent, by the Applicant with the strain Bifidobacterium breve MB233.

1. A method for improving the organoleptic properties of fermented soymilk, said method comprising the following steps:
i) mixing the soymilk with at least one product of vegetable origin containing starch and/or hydrolysis products thereof;
ii) leaving the mixture of step i) to rest with at least one bacterium selected from the species S. thermophilus.

2. The method according to claim 1, wherein the product of vegetable origin containing starch and/or hydrolysis products thereof is obtained by means of thermal, chemical and/or enzymatic treatment of at least one vegetable flour.

3. The method according to claim 2, wherein the at least one vegetable flour is selected from flour obtained from cereals or tuber crop.

4. The method according to claim 3, wherein the tuber crop is tapioca.

5. The method according to claim 1, wherein the product of vegetable origin containing starch and/or hydrolysis products thereof is a syrup or molasses or an aqueous solution containing glucose and/or maltose and/or fructose and/or complex carbohydrates having a higher molecular weight.

6. The method according to claim 1, wherein the quantitative proportion of the product of substantially vegetal origin to the soymilk in step (i) is from 0.1% to 50% v/v, preferably from 1% to 25% v/v, more preferably from 2% to 10% v/v.

7. The method according to claim 1, wherein the at least one bacterium of S. thermophilus comprises at least one bacterium selected from the group of strains consisting of:
S. thermophilus as deposited with Deutsche Sammlung von Mikroorganismen and Zellkulturen GmbH on Feb. 26, 2004 and identified by deposit number DSM 16591,
S. thermophilus as deposited with Deutsche Sammlung von Mikroorganismen und Zellkulturen GmbH on Feb. 26, 2004 and identified by deposit number DSM 16593, and
S. thermophilus as deposited with Deutsche Sammlung von Mikroorganismen und Zellkulturen GmbH on Dec. 21, 2005 and identified by deposit number DSM 17843.

8. The method according to claim 1, wherein the resting stage of step (ii) lasts for a length of time varying from 1 to 20 hours, preferably from 2 to 15 hours, more preferably from 3 to 10 hours.

9. The method according to claim 1, wherein the soymilk is pre-heated, prior to being mixed in step (i), to a temperature varying from 30° C. to 70° C. for a length of time varying from 1 to 30 minutes.

10. Soymilk comprising at least one product of vegetable origin containing starch and/or hydrolysis products thereof, said soymilk being fermented by means of at least one bacterium selected from the species S. thermophilus.

11. Soymilk according to claim 10, wherein the at least one bacterium selected from the species S. thermophilus comprises at least one bacterium selected from the group of strains consisting of:
S. thermophilus as deposited with Deutsche Sammlung von Mikroorganismen und Zellkulturen GmbH on Feb. 26, 2004 and identified by deposit number DSM 16591,
S. thermophilus as deposited with Deutsche Sammlung von Mikroorganismen und Zellkulturen GmbH on Feb. 26, 2004 and identified by deposit number DSM 16593, and
S. thermophilus as deposited with Deutsche Sammlung von Mikroorganismen und Zellkulturen GmbH on Dec. 21, 2005 and identified by deposit number DSM 17843.

12. Fermented soymilk that can be obtained by the method according to claim 1.

13. A soymilk-based food product according to claim 10.
